(19) United States
(12) Patent Application Publication
(10) Pub. No.: US 2004/0011784 A1
(43) Pub. Date: Jan. 22, 2004

(54) Egg handling pasteurization apparatus and method

(76) Inventor: Richard J. Dibbs, Northville, MI (US)

Correspondence Address: KENYON & KENYON, ONE BROADWAY, NEW YORK, NY, 10004, US

(21) Appl. No.: 10/618,971

(22) Filed: Jul. 14, 2003

Related U.S. Application Data
(62) Division of application No. 10/210,430, filed on Aug. 1, 2002.
(60) Provisional application No. 60/323,326, filed on Sep. 20, 2001.

(51) Int. Cl. H05B 6/64

(52) U.S. Cl. 219/679; 219/680

(57) ABSTRACT

An in-shell egg pasteurization system configured to pasteurize and handle eggs includes a loading system configured to accept and load an in-shell egg. The system also includes a microwave system configured to impart microwave energy to the yolk of the in-shell egg to heat the yolk to a first predetermined temperature and to impart microwave energy to the albumen of the in-shell egg to heat the albumen to a second predetermined temperature.

### CROSS-REFERENCE TO RELATED APPLICATIONS

The present application claims the benefit of U.S. Provisional Patent Application No. 60/323,326, filed on Sep. 20, 2001, which is expressly incorporated herein in its entirety by reference thereto.

### FIELD OF THE INVENTION

The present invention relates to an apparatus and method for handling and pasteurizing shell eggs. More specifically, the invention relates to an apparatus and method for high-speed/high-volume handling and pasteurization of shell eggs through a loading system and a microwave system configured to impart microwave energy to yolk and albumen parts of individual eggs.

### BACKGROUND INFORMATION

Pasteurization and protection of food products from contamination is an important and needed process for the food industry. Certain food products, such as eggs, are not readily protected from contamination due to their physical characteristics. In the case of eggs, the shell provides a barrier to treatment of the interior contents.

Eggs are among the most nutritious foods, however, they are perishable just like raw meat, poultry, and fish. Unbroken, clean, fresh shell eggs may contain Salmonella Enteritidis (SE) bacteria that can cause food borne illness. Bacteria can be inside an uncracked, whole egg. Contamination of eggs may be due to bacteria within the hen's ovary or oviduct before the shell forms around the yolk and albumen. It is also possible for eggs to become infected by Salmonella Enteritidis fecal contamination through the pores of the shells after they are laid.

Although not readily perceived, contamination of eggs takes many forms. Eggs produced by chicken or other fowl may be contaminated both internally and/or externally. This contamination includes pathogens, such as Salmonella Enteritidas, which may cause acute cases of food poisoning to individuals ingesting the contaminated food.

The Food and Drug Administration (FDA) published a final rule in the Federal Register of Dec. 5, 2000 (65 FR 76092) entitled, “Food Labeling, Safe Handling Statements, Labeling of Shell Eggs; Refrigeration of Shell Eggs Held for Retail Distribution.” The final rule applies to shell eggs that have not been specifically processed to destroy all live Salmonella before distribution to the consumer. For these shell eggs, retail establishments must include the following safe handling statement on the label of the shell eggs:

Safe Handling Instructions: To prevent illness from bacteria: keep eggs refrigerated, cook eggs until yolks are firm, and cook foods containing eggs thoroughly.

FDA required these actions to reduce the risk of illness and death caused by Salmonella Enteritidis. Eggs that have been treated to destroy Salmonella—by in-shell pasteurization, for example—are not required to carry safe handling instructions. FDA's criterion for pasteurization is a 5-log count reduction in total Salmonella count.

Current and past shell egg pasteurization technologies have concentrated in driving heat into the egg from the outside to the inside of the egg. These technologies tend to be very large, off line, batch systems that require a great deal of floor space and high capital cost. With these systems, raising the yolk temperature to the required levels, and holding it at those levels, requires driving heat into the egg through the shell and the temperature sensitive albumen. This type of processing requires a gradual and gentle heating cycle that greatly increases the time required to fully pasteurize the egg, and makes in-line pasteurization of shell eggs impractical. Egg quality tends to suffer as well, as the temperature sensitive albumen begins to change from clear to cloudy during the prolonged exposure to heat.

Pasteurization of eggs may take many forms depending upon the form of the egg being pasteurized. Eggs in a liquid stream are pasteurized through a heat-treating process to kill pathogens. Conventional liquid pasteurization processes involve providing a liquid egg stream, heating the liquid egg stream to a predetermined temperature for a specific time, and then cooling the stream. Several advances in pasteurization of liquid egg streams have occurred. In these advances the yolks are separated from the albumens. The separate streams are heated to differing predetermined temperatures before recombining the liquid yolk and albumen streams.

Conventional in-shell egg pasteurization methods include enveloping and maintaining eggs in a heated fluid until the eggs are pasteurized through heat transfer from the fluid to the eggs. Water and air are often used as the heat transfer medium. In these methods, in-shell eggs may also be subjected to a fluid pre-heater to raise the temperature of the egg prior to further pasteurization steps.

Such in-shell techniques also have drawbacks. Use of a fluid during preheating can result in uneven heating of eggs as the sensitive albumens, positioned on the periphery of the egg, heat before the interior yolks. To circumvent this problem, low pasteurization temperatures are selected for processing bulk in-shell eggs, necessitating longer egg residence time for heating. To heat the fluid and eggs, significant amounts of energy must be expended to effectively pasteurize the egg. Machinery must also be used to pump and control the pre-heater fluids, increasing capital and operating costs.

It is therefore an object of the present invention to provide an apparatus and method for high-speed/high-volume handling and pasteurizing of shell eggs through a shell egg grading and packing line while minimizing egg quality degradation.

It is another object of the present invention to provide an apparatus and method to handle, pasteurize and pack in-shell eggs while preventing egg degradation.

It is another object of the present invention to provide an apparatus and method that will pasteurize eggs based upon individual egg attributes and/or characteristics.

It is a further object of the present invention to perform pasteurization of in-shell eggs at higher temperatures than currently used to boost pasteurization speed and resulting processing times.

It is a further object of the present invention to perform pasteurization of in-shell eggs at higher temperatures than currently used by heating the egg from the inside to the outside using microwave energy and doing so with reduced pasteurization times.

It is a further object of the present invention to provide a spiral heater to reduce the floor space required to allow for in-line operation of the pasteurization system and to use the heat of the spiral oven to hold temperature in the egg and not drive heat into the egg from the outside in.

It is further object of the present invention to provide a spiral cooler, separately or connected to the spiral oven, to quickly and gently lower the egg temperatures to at or near egg storage temperatures as required by the FDA.

### SUMMARY

An in-shell egg pasteurization system configured to grade, pasteurize, handle and/or package eggs according to the present invention includes a loading system configured to accept and load bulk in-shell eggs. The system also includes a microwave energy system configured to deliver energy to each egg, a spiral oven configured to hold the heat in the egg and a cooling system configured to lower the egg temperature to at or near the egg storage temperature required by the FDA.

There are two general pasteurization and grading process configurations: full system configuration and graded eggs configuration, and a total of nine specific pasteurization configurations.

The full system configuration locates the pasteurization system between the washers and weighing area of a typical high-speed egg grading system. A typical high-speed grading system includes an arrangement configured to load eggs onto the system, to wash the eggs, to inspect the eggs for cracks, leaks, dirt, and blood spots, to weigh the eggs, and to pack the eggs. There are a total of four specific pasteurization configurations for the full system configuration.

The graded eggs system configuration locates the pasteurization system between the weighing area and packers of a typical high-speed egg grading system. A typical high-speed grading system includes an arrangement configured to load eggs onto the system, to wash the eggs, to inspect the eggs for cracks, leaks, dirt, and blood spots, to weigh the eggs, and to pack the eggs. There are a total of five specific pasteurization configurations for the graded eggs system configuration.

The microwave system may be configured to impart microwave energy to the accepted in-shell egg wherein a first quantity of microwave energy is imparted to a yolk of the accepted in-shell egg. The microwave system may also configured to impart a second quantity of microwave energy to an albumen of the accepted in-shell egg to pasteurize the accepted in-shell egg.

A second example embodiment of the in-shell egg pasteurization system according to the present invention includes a loading system configured to accept bulk in-shell eggs. The pasteurization system also includes a grading system configured to grade the accepted bulk in-shell eggs and a microwave system configured to impart a first quantity of microwave energy to a yolk of the accepted in-shell egg and impart a second quantity of microwave energy to an albumen of the accepted in-shell egg to pasteurize the accepted in-shell egg.

A method of producing pasteurized in-shell eggs according to the present invention includes the steps of: providing bulk in-shell eggs; determining an individual egg yolk weight of an individual egg yolk; determining an individual egg yolk temperature; microwaving the individual egg yolk in accordance with the determined egg yolk weight to pasteurize the egg yolk; and microwaving the individual egg albumen in accordance with the determined egg albumen weight to pasteurize the egg albumen.

A second example embodiment of a method of producing pasteurized in-shell eggs according to the present invention includes the steps of: providing bulk in-shell eggs; heating the bulk in-shell eggs in an equilibrator to a set temperature for a desired time; determining an individual egg yolk weight of an egg yolk in an individual egg; determining an individual egg yolk temperature; determining an individual egg albumen weight of the individual egg; microwaving the individual egg yolk in accordance with the determined egg yolk weight and temperature to pasteurize the egg yolk; and microwaving the individual egg albumen in accordance with the determined egg albumen weight to pasteurize the egg albumen.

### BRIEF DESCRIPTION OF THE DRAWINGS

FIG. 1 is a top plan view of an in-shell egg handling, microwave pasteurizing and packing apparatus according to a first example embodiment of the present invention.

FIG. 2 is a top plan view of an in-shell egg handling, microwave-heat pasteurizing and packing apparatus according to a second example embodiment of the present invention.

FIG. 3 is a top plan view of an in-shell egg handling, equilibrator-microwave pasteurizing and packing apparatus according to a third example embodiment of the present invention.

FIG. 4 is a top plan view of an in-shell egg handling, equilibrator-microwave-heat pasteurizing and packing apparatus according to a fourth example embodiment of the present invention.

FIG. 5 is a top plan view of an in-shell egg handling, microwave pasteurizing and packing apparatus according to a fifth example embodiment of the present invention.

FIG. 6 is a top plan view of an in-shell egg handling, microwave-heat pasteurizing and packing apparatus according to a sixth example embodiment of the present invention.

FIG. 7 is a top plan view of an in-shell egg handling, equilibrator-microwave pasteurizing and packing apparatus according to a seventh example embodiment of the present invention.

FIG. 8 is a top plan view of an in-shell egg handling, equilibrator-microwave-heat pasteurizing and packing apparatus according to an eighth example embodiment of the present invention.

FIG. 9 is a top plan view of an in-shell egg handling, heat pasteurizing and packing apparatus according to a ninth example embodiment of the present invention.

### DETAILED DESCRIPTION

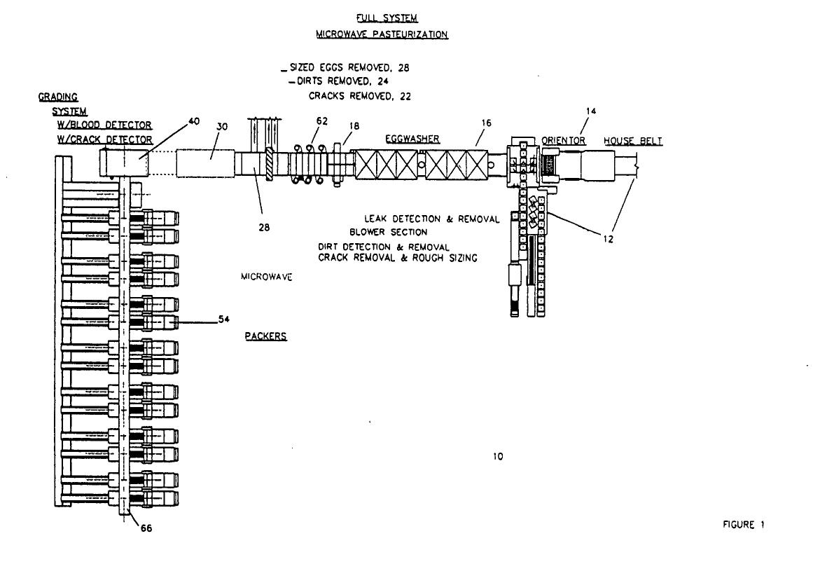

The full system configurations are described below with reference to FIGS. 1 to 4.

Referring to FIG. 1, a first example embodiment of a system 10 configured to handle, pasteurize and package in-shell eggs according to the present invention is illustrated. The common components of the configurations illustrated in FIGS. 1 to 4 are first described below. Individual unique configurations illustrated in FIGS. 1 to 4 are then described.

The system 10 is configured to couple egg handling capabilities and in-shell pasteurization with a high-speed egg grading system 40 to pasteurize and package eggs in large quantities. Processing rates may vary based on the performance of the grading system and product need based on customer requirements. The system 10 includes a series of stations including a loading system 12, an orientor 14, an egg washer 16, an egg dryer 62, a leak detector and removal system 18, a crack detector and removal system 22, a dirt detector and removal system 24, a sizing and removal system 28, one of four full system pasteurization configurations 30, a grading system 40, a basket conveyor 66, and packers 54.

As illustrated in FIGS. 1 to 4, the system 10 is configured to receive eggs through a loading system 12. The loading system 12 may include, for example, a house belt, a semi-automatic or automatic loading device, other forms of roller or belted conveying devices, etc. Additionally, eggs in loose orientation may be accepted by the system 10. The loading system 12 may include, for example, an egg loader and pre-loader configured to provide eggs to the system 10 in an oriented or non-oriented fashion. If the loading system 12 includes a loader, the loader may be of the type described in U.S. Pat. No. 4,355,936, which is expressly incorporated herein in its entirety by reference thereto. Eggs are delivered to the system 10 in bulk quantities and may be graded and/or un-graded, oriented and/or non-oriented.

An orientor 14 is arranged to receive eggs from a house belt and/or other forms of roller or belted conveying devices. The orientor 14 arranges and orients the eggs to a position needed for proper operation of the system 10. For example, the eggs may be oriented and arranged in pockets on spools that make up a conveyor.

The oriented eggs move to and through an egg washer 16. The egg washer 16 is configured to clean the exterior surface of the eggs received. The egg washer 16 may include a single unit or multiple units as required by the cleaning requirements of the operation. The egg washer 16 may also include an adjustable temperature control for the water used for washing. The egg washer 16 may also provide non-toxic and non-damaging soaps, cleaning agents, etc. to aid in the washing process. Spray nozzles using controlled water pressure may be used along with mechanical abrasion, such as, for example, brushes, to aid in the cleaning process. The eggs may also be exposed to a pre-soak of liquids prior to entering the nozzle and mechanical abrasion section and may also be rinsed with water when exiting.

The eggs are then transferred from the egg washer 16 to a leak detector and removal system 18. The leak detector and removal system 18 is configured to identify and remove eggs that are leaking, using, for example, optical, sonic, electrical resistance methods, etc. for identification. Any eggs identified as leaking may be removed using, for example, vacuum, mechanical pincer, other mechanical mechanisms, etc. Removal of leaking eggs may also be facilitated using a trained operator.

The remaining, i.e., non-leaking, eggs move to and through an egg dryer 62. The eggs may be dried with, for example, heat, high velocity air, a combination thereof, etc.

The eggs are then transferred from the egg dryer 62 to a crack detector and removal system 22. The crack detector and removal system 22 is configured to identify and remove cracked eggs using, for example, the optical, sonic, or other information from the leak detector and removal system 18. The eggs may be removed using a variety of methods including vacuum, mechanical pincer, other mechanical mechanisms, etc.

The remaining eggs move to a dirt detector and removal system 24. The dirt detector and removal system 24 is configured to identify and remove eggs with surface contaminates or visually identifiable defects using optical information. The eggs may be removed using, for example, vacuum, mechanical pincer, other mechanical mechanisms, etc. Removal may also be facilitated using a trained operator. The contaminated eggs may be placed in containers or may be routed back through the system 10 to be re-washed.

The eggs exiting the dirt detector and removal system 24 move to a weighing and removal system 28. The weighing and removal system 28 is configured to identify and remove eggs within predetermined size ranges, such as jumbos and peewees, for example. The identification method may include, for example, optical or an electronic measuring scale. The eggs may be removed using vacuum, mechanical pincer, other mechanical mechanisms, etc. Information, such as weight, from the individual eggs may be stored and transmitted for use by the system 10 at a later time to identify and track individual eggs.

The remaining eggs then move to one of four full system pasteurization configurations described below in the like-named section. These configurations are further detailed by the description below.

The remaining eggs exiting one of the four full system pasteurization configurations move to a grading system 40. The grading system 40 is configured to scale each egg, detect for cracks, and detect for blood spots inside the egg. The eggs are automatically delivered to their predetermined locations, for example, by a basket conveyor 66, based on product quality, product attributes, production requirements, etc.

The eggs are then transferred from the grading system 40 to automatic packers 54. The automatic packers 54 package the eggs in a variety of containers and packages based on production requirements.

Full System Pasteurization Configurations

1. Microwave

FIG. 1 is a top plan view of an in-shell egg handling, microwave pasteurizing and packing apparatus according to the present invention. As illustrated in FIG. 1, the eggs exiting the weighing and removal system 28 are transferred to a microwave system 30. The weight obtained from the individual eggs in the weighing and removal system 28 may be used to determine a quantity of microwave energy to be imparted to the egg. An egg yolk weight is calculated or sensed by the microwave system 30. The microwave system 30 also senses an egg yolk temperature. Based on the weight and temperature of each yolk, each yolk is subjected to microwave energy to raise the yolk temperature to within a range of, for example, 130° F. to 160° F. The eggs then travel through an albumen heater or “thermal blanket” that subjects the albumen to microwave energy to raise the albumen temperature to within a range of, for example, 100° F. to 140° F.

2. Microwave-Heat

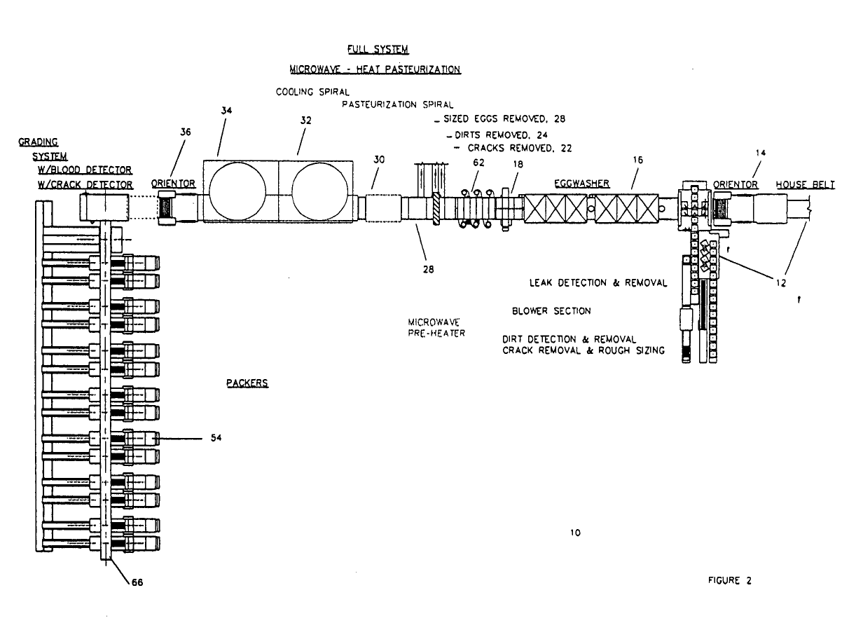

FIG. 2 is a top plan view of an in-shell egg handling, microwave-heat pasteurizing and packing apparatus according to a second example embodiment of the present invention. As illustrated in FIG. 2, the eggs exiting the sizing and removal system 28 are transferred to a microwave system 30. The eggs are weighed. Alternatively, information from the previous weighing may be used by the microwave system 30. The microwave system 30 additionally calculates or senses an egg yolk weight. Individual egg yolk temperatures are also sensed by the microwave system 30. Based on the weight and temperature of each yolk, each yolk is subjected to microwave energy to raise the yolk temperature to within a range of, for example, 130° F. to 160° F. The eggs then travel through the albumen heater or “thermal blanket” that subjects the albumen to microwave energy to raise the individual albumen temperature to within a range of, for example, 100° F. to 140° F.

The eggs are then transferred to a spiral oven 32 that maintains a specified pasteurization temperature over a specified time interval. The heating medium for may be, for example, hot air, steam, other appropriate heating medium, a combination thereof, etc. The temperature may range, for example, between 120° F. and 140° F., and the time may range, for example, between 10 minutes and 90 minutes. Heating temperatures and times may be modified at the discretion of the operator in accordance with predetermined temperatures, temperature ranges, times, time ranges, etc. as described herein.

The eggs exiting the spiral oven 32 are transferred to a spiral cooler 34. The spiral cooler 34 may use any refrigeration technique, such as, for example, mechanical refrigeration, cryogenic gases as the cooling medium, etc. The temperature of each egg is reduced to a range of, for example, 45° F. to 75° F., and the refrigeration time may range between, for example, 1 minute and 20 minutes. The spiral oven 32 and cooler 34 may be housed in a common housing unit or may be separate. As with the spiral oven 32, the operator may modify times and temperatures as needed.

The eggs exiting the cooler 34 may then be reoriented using an orientor 36, or they may remain oriented throughout the process.

3. Equilibrator-Microwave

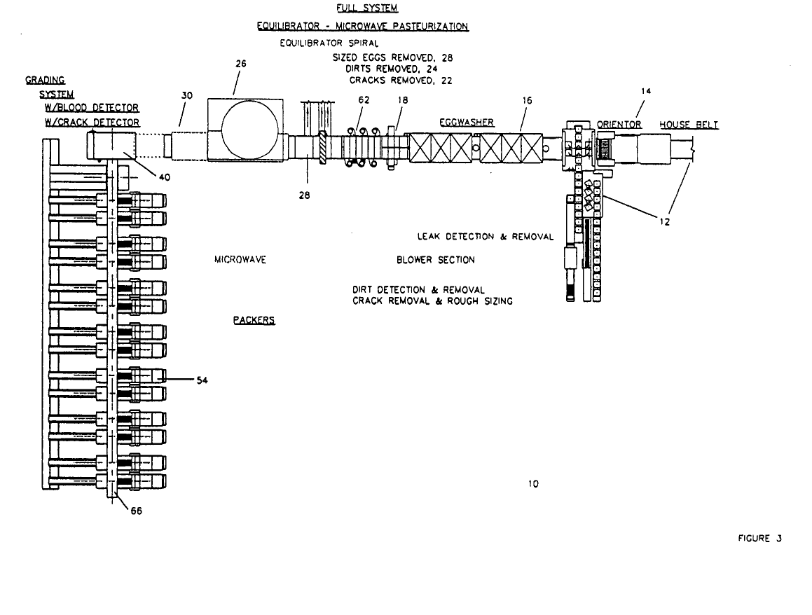

FIG. 3 is a top plan view of an in-shell egg handling, equilibrator-microwave pasteurizing and packing apparatus according to a third example embodiment of the present invention. As illustrated in FIG. 3, the remaining eggs exiting from the weighing and removal system 28 are transferred to a spiral equilibrator 26. The spiral equilibrator 26 raises the temperature of the remaining eggs to a set temperature in the range of, for example, 100° F. to 130° F. The heating medium may be hot air, steam, other heating medium, a combination thereof, etc.

The remaining eggs are transferred from the spiral equilibrator 26 to a microwave system 30. The eggs are weighed, or information from the previous weighing step is used. The egg yolk weight is either calculated or sensed. The egg yolk temperature is also sensed. Based on the size and temperature of each yolk, each yolk is subjected to microwave energy to raise its temperature to within a range of, for example, 130° F. to 160° F. The eggs then travel through the albumen heater or “thermal blanket” that subjects the albumen to microwave energy to raise its temperature to within a range of, for example, 100° F. to 140° F.

4. Equilibrator-Microwave-Heat

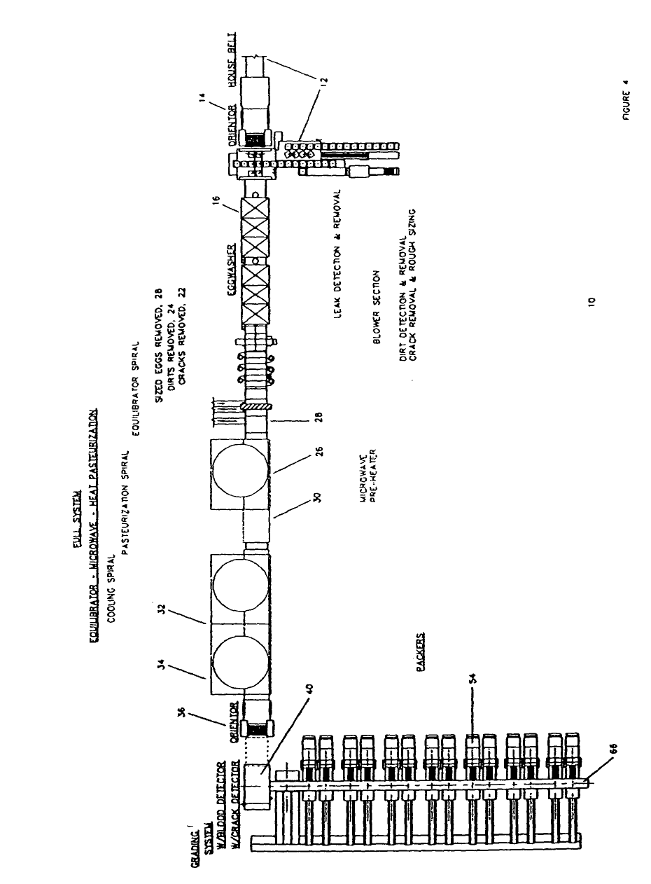

FIG. 4 is a top plan view of an in-shell egg handling, equilibrator-microwave-heat pasteurizing and packing apparatus according to a fourth example embodiment of the present invention. As illustrated in FIG. 4, the remaining eggs are transported from the weighing and removal system 28 to a spiral equilibrator 26. The spiral equilibrator 26 brings the temperature of the remaining eggs to a set temperature in the range of, for example, 100° F. to 130° F. The heating medium may be hot air, steam, other heating medium, a combination thereof, etc.

The remaining eggs are transferred from the spiral equilibrator 26 to a microwave system 30. The eggs are weighed, or information from the previous weighing step is used. The egg yolk weight is either calculated or sensed. The egg yolk temperature is also sensed. Based on the size and temperature of each yolk, each yolk is subjected to microwave energy to raise its temperature to within a range of, for example, 130° F. to 160° F. The eggs then travel through the albumen heater or “thermal blanket” that subjects the albumen to microwave energy to raise its temperature to within a range of, for example, 100° F. to 140° F.

The eggs are transferred from the microwave system 30 to a spiral oven 32 that maintains a specified pasteurization temperature over a specified time interval. The temperature may range, for example, between 120° F. and 140° F., and the time may range, for example, between 10 minutes and 90 minutes. The heating medium may be, for example, hot air, steam, other heating medium, a combination thereof, etc. The operator may modify both temperatures and times as needed.

The eggs are transferred from the spiral oven 32 to a spiral cooler 34. The spiral cooler 34 may use, for example, mechanical refrigeration or cryogenic gases as the cooling medium, etc. The temperature of each egg is reduced to a range of, for example, 45° F. to 75° F., and the time may range between, for example, 1 minute and 20 minutes.

The eggs are reoriented using an orientor 36, or they remain oriented throughout the process.

Graded Eggs Configuration

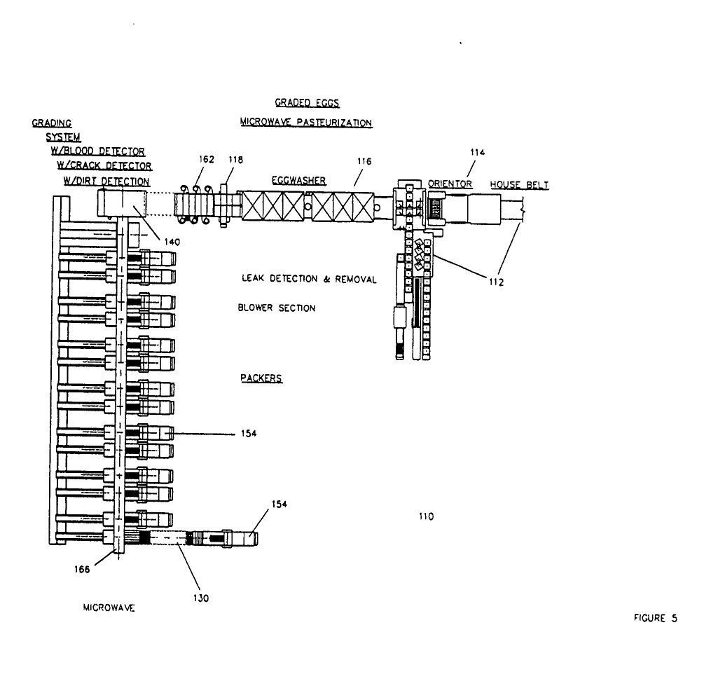

Referring to FIG. 5, an example embodiment of a system 110 configured to handle, pasteurize, and package in-shell graded eggs according to the present invention is illustrated. The common components of the graded eggs configurations, illustrated in FIGS. 5 to 9, are first described below. Each of the unique pasteurization configurations illustrated in FIGS. 5 to 9 are then be described in a following section entitled “GRADED EGGS PASTEURIZATION CONFIGURATIONS.”

An in-shell pasteurization system 110 is configured to couple egg handling capabilities and in-shell pasteurization with a high-speed egg grading system 140 to pasteurize and package eggs in large quantities. Processing rates may be varied based on the performance of an attached grading system and/or product need based on customer requirements. The system 110 includes a series of stations including a loading system 112, an orientor 114, an egg washer 116, an egg dryer 162, a leak detector and removal system 118, a grading system 140, packers 154, one of five graded eggs pasteurization systems, and a packer 154.

As illustrated in FIGS. 5 to 9, the system 110 is configured to receive eggs through a loading system 112. The loading system 112 may include, for example, a house belt and/or a semi-automatic or automatic loading device, and/or other forms of roller or belted conveying devices, etc. Eggs in loose orientation may also be accepted by the system 110. The loading system 112 may include, for example, an egg loader and pre-loader configured to provide eggs to the system in an oriented or non-oriented fashion. If the loading system 12 includes a loader, the loader described, for example, in U.S. Pat. No. 4,355,936, which is expressly incorporated herein in its entirety by reference thereto, may be provided. Eggs are delivered to the system in bulk quantities and may be graded and/or un-graded, oriented and/or non-oriented.

An orientor 114 is arranged to receive eggs from a house belt and/or other forms of roller or belted conveying devices. The orientor 114 arranges and orients the flow of eggs in a fashion needed for proper operation of the system 110. For example, the eggs may be oriented and arranged in pockets on spools that make up a conveyor.

The oriented eggs move to and through an egg washer 116. The egg washer 116 is configured to clean the exterior surface of the eggs received. The egg washer 116 may include a single unit or multiple units as required by the cleaning requirements of the operation. The egg washer 116 includes an adjustable temperature control for the water used for washing. The egg washer 116 may also provide non-toxic or non-damaging soaps or cleaning agents, etc. to aid in the washing process. Spray nozzles using controlled water pressure may be used along with mechanical abrasion, such as with brushes, etc. to aid in the cleaning process. The eggs may also be exposed to a pre-soak of liquids prior to entering the nozzle and mechanical abrasion section and may also be rinsed with water when exiting.

The washed eggs exit the egg washer 116 and move to and through an egg dryer 162. The eggs may be dried with heat, high velocity air, a combination thereof, etc.

The dried eggs then move to a leak detector and removal system 118. The leak detector and removal system 118 is configured to identify and remove eggs that are leaking, using, for example, optical, sonic, or electrical resistance methods, etc. for identification. Any eggs identified as leaking are removed using, for example, vacuum, mechanical pincer, other mechanical mechanisms, etc. Removal may also be facilitated using a trained operator.

The remaining eggs move to a grading system 140. The grading system 140 is configured to scale each egg, detect for dirt eggs, detect for cracks, and detect for blood spots inside the egg. The eggs are automatically delivered to predetermined locations, for example, by a basket conveyor 166, based on product quality, product attributes, production requirements, etc. Information obtained from scaling may be optionally saved and transmitted to a microwave system 130

The remaining eggs move to one of five graded eggs pasteurization configurations or move to automatic packers 154. These individual pasteurization configurations are further detailed in the section below, entitled “GRADED EGGS PASTEURIZATION CONFIGURATIONS.”

The pasteurized eggs are then transferred to an automatic packer 154. The automatic packer 154 packages the eggs in a variety of containers and packages based on production requirements.

Graded Eggs Pasteurization Configurations

1. Microwave

FIG. 5 is a top plan view of an in-shell egg handling, microwave pasteurizing and packing apparatus according to a fifth example embodiment of the present invention. As illustrated in FIG. 5, graded eggs are transferred to a microwave system 130. The eggs may be weighed, or weight information from a previous weighing step may be obtained. An individual egg yolk weight is either calculated or sensed. The system also determines or senses an individual egg yolk temperature. Based on the size and temperature of each yolk, each yolk is subjected to microwave energy to raise the yolk temperature to within a range of, for example, 130° F. to 160° F. The eggs then travel through an albumen heater or “thermal blanket” that subjects the albumen to microwave energy to raise the albumen temperature to within a range of, for example, 100° F. to 140° F.

2. Microwave-Heat

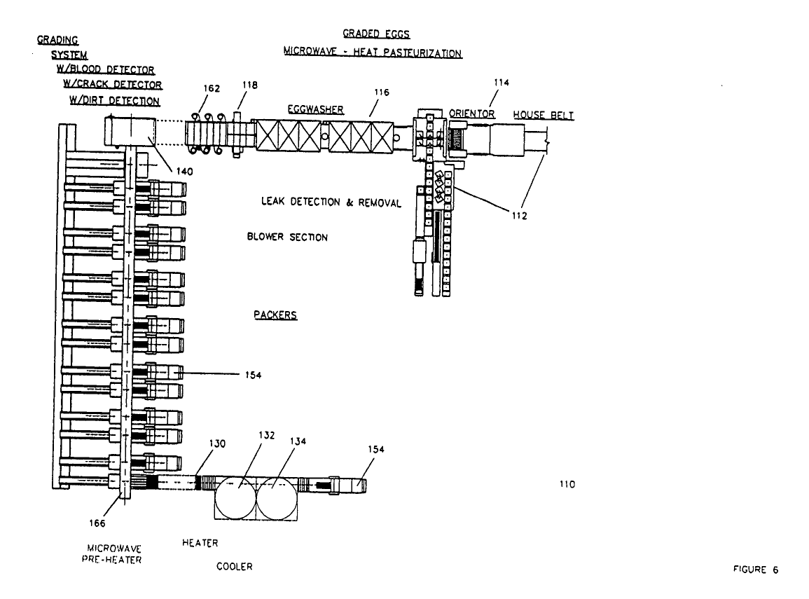

FIG. 6 is a top plan view of an in-shell egg handling, microwave-heat pasteurizing and packing apparatus according to a sixth example embodiment of the present invention. As illustrated in FIG. 6, the graded eggs are transferred to a microwave system 130. The eggs are weighed, or information from the previous weighing step is used. The egg yolk weight is calculated or sensed. The egg yolk temperature is also sensed. Based on the size and temperature of each yolk, each yolk is subjected to microwave energy to raise its temperature to within a range of, for example, 130° F. to 160° F. The eggs then travel through the albumen heater or “thermal blanket” that subjects the albumen to microwave energy to raise its temperature to within a range of, for example, 100° F. to 140° F.

The eggs are transferred to a spiral oven 132 that maintains a specified pasteurization temperature over a specified time interval. The temperature may range, for example, between 120° F. and 140° F., and the time may range, for example, 10 minutes and 90 minutes. The heating medium may be hot air, steam, other heating medium, a combination thereof, etc.

The eggs are transferred to a spiral cooler 134. The spiral cooler 134 may use mechanical refrigeration, cryogenic gases as the cooling medium, etc. The temperature of each egg is reduced to a range of, for example, 45° F. to 75° F., and the time may range, for example, between 1 minute and 20 minutes.

3. Equilibrator-Microwave

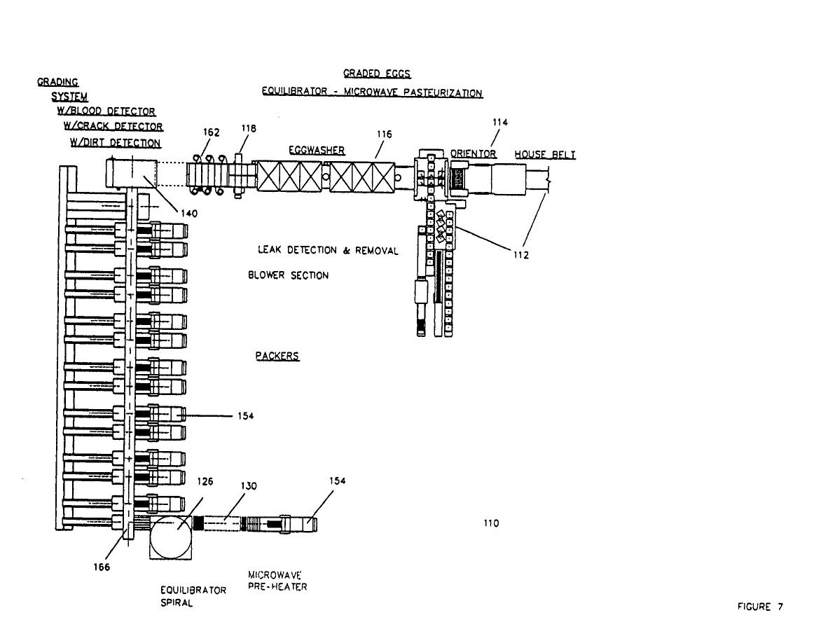

FIG. 7 is a top plan view of an in-shell egg handling, equilibrator-microwave pasteurizing and packing apparatus according to a seventh example embodiment of the present invention. As illustrated in FIG. 7, the graded eggs are transferred to the spiral equilibrator 126. The equilibrator spiral 126 brings the temperature of the eggs to a set temperature in the range of, for example, 100° F. to 130° F. The heating medium may be hot air, steam, other heating medium, a combination thereof, etc.

The remaining eggs are transferred to the microwave system 130. The eggs are weighed, or information from the previous weighing step is used. The egg yolk weight is calculated or sensed. Based on the size and temperature of each yolk, each yolk is subjected to microwave energy to raise its temperature to within a range of, for example, 130° F. to 160° F. The eggs then travel through the albumen heater or “thermal blanket” that subjects the albumen to microwave energy to raise its temperature to within a range of, for example, 100° F. to 140° F.

4. Equilibrator-Microwave-Heat

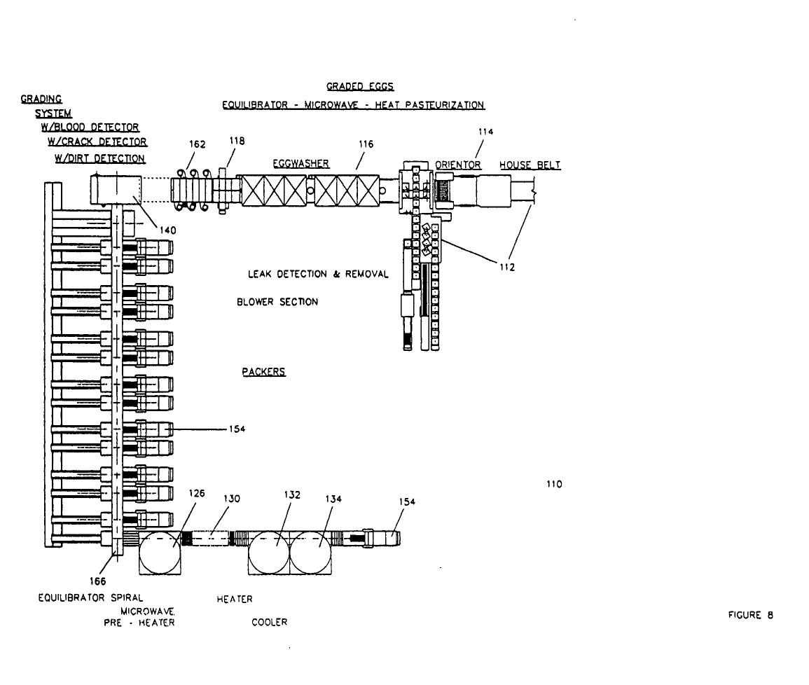

FIG. 8 is a top plan view of an in-shell egg handling, equilibrator-microwave-heat pasteurizing and packing apparatus according to an eighth example embodiment of the present invention. As illustrated in FIG. 8, the graded eggs are transferred to the spiral equilibrator 126. The spiral equilibrator 126 brings the temperature of the eggs to a set temperature in the range of, for example, 100° F. to 130° F. The heating medium may be, for example, hot air, steam, other heating medium, a combination thereof, etc.

The remaining eggs are transferred to the microwave system 130. The eggs are weighed, or information from the previous weighing step is used. The egg yolk weight is calculated or sensed. Based on the size and temperature of each yolk, each yolk is subjected to microwave energy to raise its temperature to within a range of, for example, 130° F. to 160° F. The eggs then travel through the albumen heater or “thermal blanket” that subjects the albumen to microwave energy to raise its temperature to within a range of, for example, 100° F. to 140° F.

The eggs are transferred to a spiral oven 132 that maintains a specified pasteurization temperature over a specified time interval. The temperature may range, for example, between 120° F. and 140° F., and the time may range, for example, between 10 minutes and 90 minutes. The heating medium may be, for example, hot air, steam, other heating medium, a combination thereof, etc.

The eggs are transferred to a spiral cooler 134. The spiral cooler 134 may, for example, use mechanical refrigeration or cryogenic gases as the cooling medium, etc. The temperature of each egg is reduced to a range of, for example, 45° F. to 75° F., and the time may range between, for example, 1 minute and 20 minutes.

5. Heat

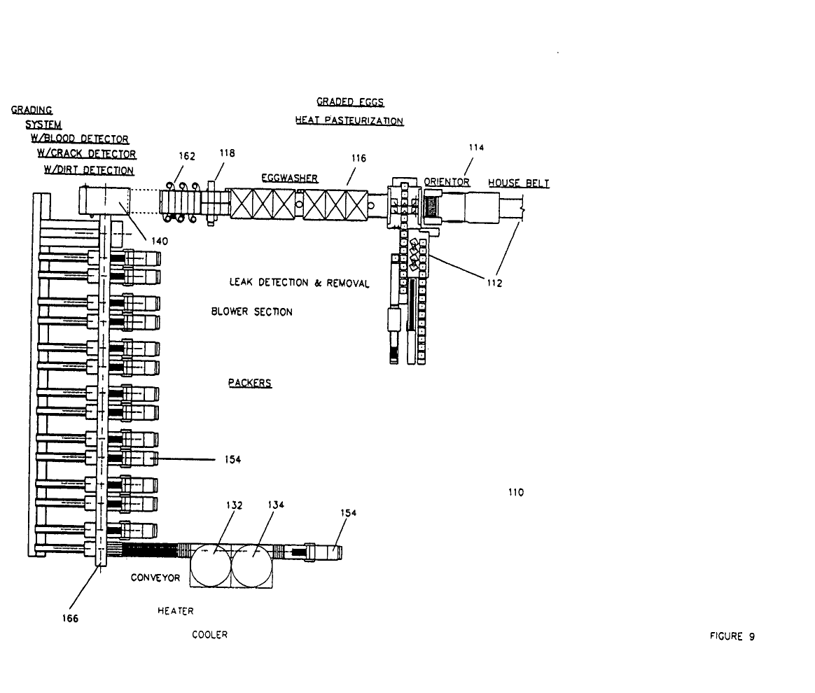

FIG. 9 is a top plan view of an in-shell egg handling, heat pasteurizing and packing apparatus according to a ninth example embodiment of the present invention. As illustrated in FIG. 9, the graded eggs are transferred to a spiral oven 132 that increases the egg temperature to a specified temperature over a specified time interval. The temperature may range, for example, between 120° F. and 140° F., and the time may range, for example, between 10 minutes and 120 minutes. The heating medium may be, for example, hot air, steam, other heating medium, a combination thereof, etc.

The eggs are transferred to a spiral cooler 134. The spiral cooler 134 may use, for example, mechanical refrigeration or cryogenic gases as the cooling medium, etc. The temperature of each egg is reduced to a range of, for example, 45° F. to 75° F., and the time may range between, for example, 1 minute to 20 minutes.

What is claimed is:

1. An in-shell egg pasteurization system configured to pasteurize and handle eggs comprising:
a loading system configured to accept an in-shell egg; and
a microwave system configured to impart microwave energy to a yolk of the in-shell egg in accordance with at least one of a size and a temperature of the yolk to heat the yolk to a first predetermined temperature and to impart microwave energy to an albumen of the in-shell egg to heat the albumen to a second predetermined temperature.

2. The system according to claim 1, further comprising a packer configured to pack the in-shell egg, the packer arranged one of downstream and upstream of the microwave system.

3. The system according to claim 1, further comprising a high-speed grading system configured to grade the in-shell egg, the grading system arranged one of downstream and upstream of the microwave system.

4. The system according to claim 1, further comprising an egg washer configured to wash an exterior of the in-shell egg.

5. The system according to claim 4, further comprising an egg dryer configured to dry the in-shell egg.

6. The system according to claim 1, further comprising a leak detector and removal system configured to identify and remove the in-shell eggs having a leak.

7. The system according to claim 1, further comprising a crack detector and removal system configured to identify and remove the in-shell egg having a crack.

8. The system according to claim 1, further comprising a dirt detector and removal system configured to identify and remove an in-shell egg having dirt on a surface.

9. The system according to claim 1, further comprising a weighing and removal system configured to determine a weight of the in-shell egg.

10. The system according to claim 9, wherein the weighing and removal system is configured to remove the in-shell egg in accordance with at least one of the weight and a starting temperature.

11. The system according to claim 9, wherein the microwave system is configured to impart the microwave energy to at least one of the yolk and the albumen in accordance with the weight.

12. The system according to claim 1, further comprising an oven configured to maintain the in-shell egg at a predetermined pasteurization temperature for a predetermined time interval arranged downstream of the microwave system.

13. The system according to claim 12, wherein the predetermined pasteurization temperature is in a range of between 120° F. and 140° F.

14. The system according to claim 12, wherein the predetermined time interval is between 10 minutes and 90 minutes.

15. The system according to claim 12, wherein the oven includes a heating medium.

16. The system according to claim 15, wherein the heating medium includes at least one of hot air and steam.

17. The system according to claim 1, further comprising a cooler configured to cool the in-shell egg.

18. The system according to claim 17, wherein the cooler is configured to cool the in-shell egg to a temperature in a range of between 45° F. and 75° F.

19. The system according to claim 1, further comprising an equilibrator arranged upstream of the microwave system, the equilibrator configured to heat the in-shell egg to a third predetermined temperature.

20. The system according to claim 19, wherein the third predetermined temperature is in a range of between 100° F. and 130° F.

21. The system according to claim 1, wherein the first predetermined temperature is in a range of between 130° F. and 160° F.

22. The system according to claim 1, wherein the second predetermined temperature is in a range of between 100° F. and 140° F.

23. An in-shell egg pasteurization system to pasteurize and handle graded eggs, comprising:
a loading system configured to accept an in-shell egg;
a grading system configured to grade the in-shell egg; and
a microwave system configured to impart microwave energy to a yolk of the in-shell egg in accordance with at least one of a size and a temperature of the yolk to heat the yolk to a first predetermined temperature and to impart microwave energy to an albumen of the in-shell egg heat the albumen to a second predetermined temperature.

24. The system according to claim 23, further comprising a packer configured to pack the in-shell egg, the packer arranged downstream of the microwave system.

25. The system according to claim 23, further comprising a packer configured to pack the in-shell egg, the microwave system arranged between the packer and the grading system.

26. The system according to claim 23, further comprising an egg washer configured to wash an exterior of the in-shell egg.

27. The system according to claim 26, further comprising an egg dryer configured to dry the in-shell egg.

28. The system according to claim 23, further comprising a leak detector and removal system configured to detect the in-shell egg having a leak.

29. The system according to claim 23, further comprising an oven configured to maintain the in-shell egg at a predetermined pasteurization temperature for a predetermined time interval arranged downstream of the microwave system.

30. The system according to claim 29, wherein the predetermined pasteurization temperature is in a range of between 120° F. and 140° F.

31. The system according to claim 29, wherein the predetermined time interval is in a range of between 10 minutes and 90 minutes.

32. The system according to claim 29, wherein the oven includes a heating medium.

33. The system according to claim 32, wherein the heating medium includes at least one of hot air and steam.

34. The system according to claim 23, further comprising a cooler configured to cool the in-shell egg.

35. The system according to claim 34, wherein the cooler is configured to cool the in-shell egg to a temperature in a range of between 45° F. and 75° F.

36. The system according to claim 23, further comprising an equilibrator arranged upstream of the microwave system, the equilibrator configured to heat the in-shell egg to a third predetermined temperature.

37. The system according to claim 36, wherein the third predetermined temperature is in a range of between 100° F. and 130° F.

38. A method for pasteurizing an in-shell egg, comprising the steps of:
determining at least one of a weight and a temperature of a yolk of the in-shell egg;
microwaving the yolk in accordance with the one of the weight and the temperature determined in the determining step to heat the yolk to a first predetermined temperature;
microwaving the albumen to heat the albumen to a second predetermined temperature.

39. The method according to claim 38, further comprising the step of maintaining the in-shell egg at a predetermined pasteurization temperature for a predetermined time interval after the microwaving steps.

40. The method according to claim 39, wherein the predetermined pasteurization temperature is in a range of between 120° F. and 140° F.

41. The method according to claim 39, wherein the predetermined time interval is in a range of between 10 minutes and 90 minutes.

42. The method according to claim 38, further comprising the step of cooling the in-shell egg after the microwaving steps.

43. The method according to claim 42, wherein the in-shell egg is cooled to a temperature in a range of between 45° F. and 75° F. in the cooling step.

44. The method according to claim 38, wherein the first predetermined temperature is in a range of between 130° F. and 160° F.

45. The method according to claim 38, wherein the second predetermined temperature is in a range of between 100° F. and 140° F.

46. The method according to claim 38, further comprising the step of heating the in-shell egg to a third predetermined temperature before the microwaving steps.

47. The method according to claim 46, wherein the third predetermined temperature is in a range of between 100° F. and 130° F.

48. The method according to claim 46, wherein the in-shell egg is heated in the heating step using a heating medium.

49. The method according to claim 48, wherein the heating medium includes at least one of hot air and steam.

50. An in-shell egg pasteurization system, comprising an oven configured to increase a temperature of an in-shell egg to a first predetermined temperature in a range of between 120° F. and 140° F. for a predetermined time interval.

51. The system according to claim 50, further comprising a cooler arranged downstream of the oven and configured to reduce the temperature of the in-shell egg to a second predetermined temperature in a range of between 45° F. and 75° F.

52. The system according to claim 50, wherein the predetermined time interval is between 10 minutes and 120 minutes.

53. The system according to claim 50, wherein the oven includes a heating medium.

54. The system according to claim 53, wherein the heating medium includes at least one of hot air and steam.

55. The system according to claim 51, wherein the cooler is configured to cool the in-shell egg for a time interval in a range of between 1 minute and 20 minutes.

56. The system according to claim 49, further comprising:
a packer configured to pack the in-shell egg; and
a grader configured to grade the in-shell egg;
wherein the oven is arranged between the packer and the grader.

57. A method of pasteurizing an in-shell egg, comprising the steps of:
heating the in-shell egg to a first predetermined temperature in a range of between 120° F. and 140° F. for a predetermined time interval; and
cooling the in-shell egg to a second predetermined temperature in a range of between 45° F. and 75° F. after the heating step.

58. The method according to claim 57, wherein the predetermined time interval is in a range of between 10 minutes and 120 minutes.

59. The method according to claim 57, wherein the in-shell egg is heated in the heating step with a heating medium.

60. The method according to claim 59, wherein the heating medium includes at least one of hot air and steam.

61. The method according to claim 57, wherein the in-shell egg is cooled in the cooling step for a predetermined time interval between 1 minute and 20 minutes.

62. An in-shell egg pasteurization system, comprising:
a microwave system configured to impart microwave energy to a yolk of the in-shell egg in accordance with at least one of a size and a temperature of the yolk to heat the yolk to a first predetermined temperature and to impart microwave energy to an albumen of the in-shell egg to heat the albumen to a second predetermined temperature.

63. The system according to claim 62, wherein the first predetermined temperature is in a range of between 130° F. and 160° F.

64. The system according to claim 62, wherein the second predetermined temperature is in a range of between 100° F. and 140° F.

65. The system according to claim 62, further comprising an equilibrator arranged upstream of the microwave system, the equilibrator configured to heat the in-shell egg to a third predetermined temperature.

66. The system according to claim 65, wherein the third predetermined temperature is in a range of between 100° F. and 130° F.

67. The system according to claim 62, further comprising an oven arranged downstream of the microwave system, the oven configured to maintain the in-shell egg at a predetermined pasteurization temperature for a predetermined time interval.

68. The system according to claim 67, wherein the predetermined pasteurization temperature is in a range of between 120° F. and 140° F.

69. The system according to claim 67, wherein the predetermined time interval is in a range of between 10 minutes and 90 minutes.

70. The system according to claim 62, further comprising a cooler arranged downstream of the microwave system, the cooler configured to cool the in-shell egg to a third predetermined temperature.

71. The system according to claim 70, wherein the third predetermined temperature is in a range of between 45° F. and 75° F.

72. The system according to claim 70, wherein the cooler is configured to cool the in-shell egg for a predetermined time interval.

73. The system according to claim 72, wherein the predetermined time interval is in a range of between 1 minute and 20 minutes.

74. A method of pasteurizing an in-shell egg, comprising the steps of:
microwaving a yolk of the in-shell egg in accordance with at least one of a size and a temperature of the yolk to heat the yolk to a first predetermined temperature; and
microwaving an albumen of the in-shell egg to heat the albumen to a second predetermined temperature.

75. The method according to claim 74, wherein the first predetermined temperature is in a range of between 130° F. and 160° F.

76. The method according to claim 74, wherein the second predetermined temperature is in a range of between 100° F. and 140° F.

77. The method according to claim 74, further comprising the step of heating the in-shell egg to a third predetermined temperature before the microwaving steps.

78. The method according to claim 77, wherein the third predetermined temperature is in a range of between 100° F. and 130° F.

79. The method according to claim 74, further comprising the step of maintaining the in-shell egg at a predetermined pasteurization temperature for a predetermined time interval after the microwaving steps.

80. The method according to claim 79, wherein the predetermined pasteurization temperature is in a range of between 120° F. and 140° F.

81. The method according to claim 79, wherein the predetermined time interval is in a range of between 10 minutes and 90 minutes.

82. The method according to claim 74, further comprising the step of cooling the in-shell egg to a third predetermined temperature after the microwaving steps.

83. The method according to claim 82, wherein the third predetermined temperature is in a range of between 45° F. and 75° F.

84. The method according to claim 82, wherein the in-shell egg is cooled in the cooling step for a predetermined time interval.

85. The method according to claim 84, wherein the predetermined time interval is in a range of between 1 minute and 20 minutes.
